(19) United States
(12) Patent Application Publication
(10) Pub. No.: US 2025/0157767 A1
(43) Pub. Date: May 15, 2025

(54) ELECTRIC CIRCUIT SWITCHING DEVICE

(71) Applicant: Daicel Corporation, Osaka (JP)

(72) Inventors: Tomohiro TSUDA, Tokyo (JP); Masahiro TSURUTA, Tokyo (JP); Tsuneki KONISHI, Tokyo (JP); Jackkrit SABMEK, Tokyo (JP)

(73) Assignee: Daicel Corporation, Osaka (JP)

(21) Appl. No.: 18/840,920

(22) PCT Filed: Feb. 25, 2022
(86) PCT No.: PCT/JP2022/008002

§ 371 Date: Aug. 23, 2024

(51) Int. Cl. H01H 39/00

(52) U.S. Cl. CPC H01H 39/004

(57) ABSTRACT

An electric circuit switching device includes an igniter provided in a housing; a tubular space formed in the housing; a projectile having conductivity, provided at a first position in the tubular space in an initial state before actuation of the igniter, and configured to be projected in a predetermined projecting direction by energy of the combustion gas; a pair of first conductor pieces provided inserted, in a spaced apart state, into the tubular space at a second position closer to the projecting direction side than the first position; and a support disposed closer to the projecting direction side than the first position in the tubular space, and configured to receive, at the second position, the projectile projected by actuation of the igniter.

### TECHNICAL FIELD

The present invention relates to an electric circuit switching device.

### BACKGROUND ART

There are known relays that protect an electric device by switching a specific electric circuit from an interrupted state to a conductive state when an abnormality occurs in the electric device. As such relays, there are known electromagnetic relays that utilize electromagnets to switch the opening and closing of the electric circuit. However, known electromagnetic relays take a long time to switch to the conductive state, causing problems such as the occurrence of a defect in which the electric device fails due to the effects of excessive current, for example.

### CITATION LIST

### Patent Literature

Patent Document 1: US 2015/248,979 A
Patent Document 2: WO 2016/169612
Patent Document 3: WO 2020/164871

### SUMMARY OF INVENTION

### Technical Problem

An object of the technology of the present disclosure is to provide an electric circuit switching device for switching a predetermined electric circuit from an interrupted state to a conductive state, the electric circuit switching device being capable of shortening a time required for switching.

### Solution to Problem

To solve the above problems, the electric circuit switching device according to the present disclosure adopts the following configuration. That is, the technology of the present disclosure is an electric circuit switching device configured to switch a predetermined first electric circuit from an interrupted state to a conductive state upon actuation. The electric circuit switching device includes a housing; an igniter provided in the housing and configured to release a combustion gas upon actuation; a tubular space formed in the housing and extending in one direction; a projectile having conductivity, positioned at a first position in the tubular space in an initial state before actuation of the igniter, and configured to be projected in a predetermined projecting direction along the tubular space by energy of the combustion gas, a pair of first conductor pieces provided inserted, in a spaced apart state, into the tubular space at a second position closer to the projecting direction side than the first position, and forming part of a first electric circuit in cooperation with each other; and a support disposed closer to the projecting direction side than the first position in the tubular space, and configured to receive, at the second position, the projectile projected by actuation of the igniter. When the igniter is actuated and the projectile is projected, the projectile deforms by collision with the support, the projectile and each of the pair of first conductor pieces come into contact with each other, and the projectile becomes engaged with the pair of first conductor pieces, switching the first electric circuit from the interrupted state to the conductive state.

Further, in the electric circuit switching device according to the present disclosure, the pair of first conductor pieces may be provided inserted at the second position in a manner that the pair of first conductor pieces oppose each other with the projectile, received by the support, interposed therebetween, the support may include a protruding portion protruding toward a side opposite to the projecting direction, and a recessed portion may be formed in an end surface of the projectile on the projecting direction side. When the igniter is actuated and the projectile is projected, the projectile may enter between the pair of first conductor pieces, the protruding portion may enter the recessed portion, and the protruding portion may deform the projectile, pressing and expanding the recessed portion, thereby increasing a width of the projectile in an arrayed direction of the pair of first conductor pieces and press-fitting the projectile between the pair of first conductor pieces.

Further, in the electric circuit switching device according to the present disclosure, the protruding portion may be formed in a triangular cross-sectional shape, increasing in width in the arrayed direction of the pair of first conductor pieces gradually from a distal end portion of the protruding portion in the projecting direction, the recessed portion may be formed in a triangular cross-sectional shape, increasing in width in the arrayed direction of the pair of first conductor pieces gradually from a bottom portion of the recessed portion in the projecting direction, and a spread angle of the protruding portion may be set larger than a spread angle of the recessed portion.

Further, in the electric circuit switching device according to the present disclosure, the pair of first conductor pieces may be provided inserted at the second position in a manner that the pair of first conductor pieces oppose each other with the projectile, received by the support, interposed therebetween, the support may include a protruding portion protruding toward a side opposite to the projecting direction, and the projectile may include a main body portion positioned at the first position in the initial state, and a pair of extending portions provided in line in the arrayed direction of the pair of first conductor pieces and extending from the main body portion in the projecting direction. When the igniter is actuated and the projectile is projected, the pair of extending portions may enter between the pair of first conductor pieces, the protruding portion may enter between the pair of extending portions, and the protruding portion may deform the projectile in a manner that the pair of extending portions are bent outward, thereby sandwiching one of the pair of first conductor pieces between one of the pair of extending portions and the main body portion and sandwiching the other of the pair of first conductor pieces between the other of the pair of extending portions and the main body portion.

Further, in the electric circuit switching device according to the present disclosure, an accommodation space configured to accommodate the pair of extending portions bent by the protruding portion may be formed between the protruding portion and each of the pair of first conductor pieces.

Further, the electric circuit switching device according to the present disclosure may further be configured to switch a predetermined second electric circuit from a conductive state to an interrupted state upon actuation. The electric circuit switching device may further include a pair of second conductor pieces provided inserted, in a spaced apart state, into the tubular space at the first position, and forming part of the second electric circuit in cooperation with each other. In the initial state, the pair of second conductor pieces may be electrically connected to each other via the projectile, causing the second electric circuit to be in the conductive state, and an electrical connection between the pair of second conductor pieces via the projectile may be disconnected when the igniter is actuated and the projectile is projected, switching the second electric circuit from the conductive state to the interrupted state.

Further, in the electric circuit switching device according to the present disclosure, in the initial state, the projectile may be interposed between the pair of second conductor pieces, integrally connecting the projectile and the pair of second conductor pieces, and the projectile may be separated from each of the pair of second conductor pieces by the energy of the combustion gas.

Further, in the electric circuit switching device according to the present disclosure, the projectile may be fitted to an inner wall of the tubular space, and the inner wall of the tubular space may be formed with a width of the tubular space decreasing in the projecting direction.

Further, the electric circuit switching device according to the present disclosure may further include a piston disposed in the tubular space, interposedly between the igniter and the projectile, and configured to be projected in the projecting direction by the energy of the combustion gas.

### Advantageous Effects of Invention

According to an electric circuit switching device of the present disclosure, it is possible to shorten the time required for switching a predetermined electric circuit from an interrupted state to a conductive state.

### BRIEF DESCRIPTION OF DRAWINGS

FIG. 1 is a vertical cross-sectional view illustrating a state before actuation of a switching device according to a first embodiment.

FIG. 2 is a front view of a projectile according to the first embodiment.

FIG. 3 is a bottom view of the projectile according to the first embodiment.

FIG. 4 is a front view of a support according to the first embodiment.

FIG. 5 is a top view of the support according to the first embodiment.

FIG. 6 is a vertical cross-sectional view illustrating a state after actuation of the switching device according to the first embodiment.

FIG. 7 is a vertical cross-sectional view illustrating a state before actuation of a switching device according to a modified example of the first embodiment.

FIG. 8 is a vertical cross-sectional view illustrating a state after actuation of the switching device according to the modified example of the first embodiment.

FIG. 9 is a vertical cross-sectional view illustrating a state before actuation of a switching device according to a second embodiment.

FIG. 10 is a front view of the projectile according to the second embodiment.

FIG. 11 is a bottom view of the projectile according to the second embodiment.

FIG. 12 is a front view of the support according to the second embodiment.

FIG. 13 is a top view of the support according to the second embodiment.

FIG. 14 is a vertical cross-sectional view illustrating a state after actuation of the switching device according to the second embodiment.

FIG. 15 is a vertical cross-sectional view illustrating a state before actuation of a switching device according to a modified example of the second embodiment.

FIG. 16 is a vertical cross-sectional view illustrating a state after actuation of the switching device according to the modified example of the second embodiment.

### DESCRIPTION OF EMBODIMENTS

An electric circuit switching device according to embodiments of the present disclosure will be described below with reference to the drawings. Note that each of configurations, combinations thereof, and the like in the embodiments are an example, and various additions, omissions, substitutions, and other changes of the configurations may be made as appropriate without departing from the spirit of the present disclosure. The present disclosure is not limited by the embodiments and is limited only by the claims.

An electric circuit switching device according to an embodiment of the present disclosure is a device installed in an electric device (or an electric facility) and configured to rapidly switch a conductive state and an interrupted state (also referred to as a “non-conductive state”) of an electric circuit. For example, the electric circuit switching device according to the embodiment can be used as a short-circuiting device that, when an abnormality occurs in the target electric device in which it is installed, short-circuits a predetermined electric circuit by urgently switching the electric circuit from an “interrupted state” of the electric circuit being interrupted to a “conductive state” of the electric circuit being conductive. As another usage example of the electric circuit switching device according to an embodiment, the electric circuit switching device can be used as a switching device that interrupts an electric circuit in a conductive state and makes another electric circuit in an interrupted state be conductive. Note that, in this specification, a “conductive state” refers to a state in which an electric circuit is electrically connected, allowing a current to run therethrough, and an “interrupted state” refers to a state in which an electric circuit is not electrically connected, not allowing a current to run therethrough.

### First Embodiment

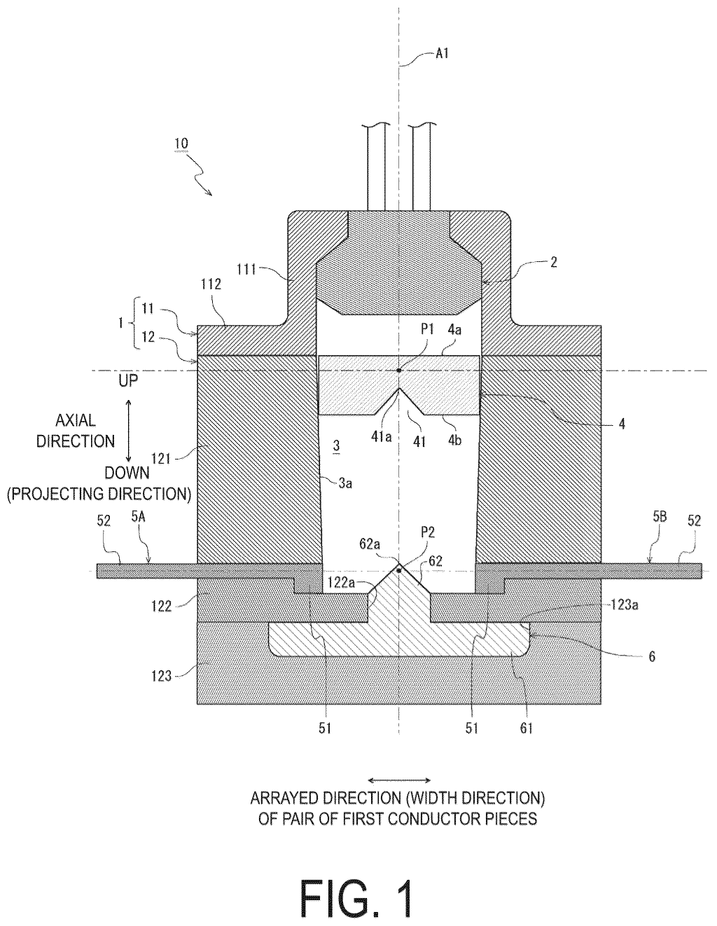

FIG. 1 is a vertical cross-sectional view for describing a state before actuation of an electric circuit switching device (hereinafter also simply referred to as “switching device”) 10 according to a first embodiment. FIG. 1 illustrates a cross section along a center axis A1 of a tubular space denoted by reference sign 3. Hereinafter, a direction along the tubular space 3 (that is, an axial direction of the tubular space 3 and an extending direction of the tubular space 3) is referred to as a “vertical direction” of the switching device 10, a side of a top housing denoted by reference sign 11 is referred to as an “upper side” in the vertical direction, and a side of housing body denoted by reference sign 12 is referred to as a “lower side” in the vertical direction. Here, as illustrated in FIG. 1, in the switching device 10, a pair of conductor pieces denoted by reference signs 5A, 5B are disposed side by side. Hereinafter, a direction orthogonal to the axial direction of the tubular space 3 and in which the pair of first conductor pieces 5A, 5B are arrayed (aligned) is referred to as “an arrayed direction of the pair of first conductor pieces 5A, 5B (or simply an arrayed direction)” or “a width direction.” FIG. 1 illustrates a cross section parallel to the vertical direction and the arrayed direction of the pair of first conductor pieces 5A, 5B. Further, in the present specification, a cross section of the switching device 10 in the vertical direction is referred to as a “vertical cross section” of the switching device 10.

### Overall Configuration

As illustrated in FIG. 1, the switching device 10 according to the first embodiment includes a housing 1, an igniter 2, the tubular space 3, a projectile 4, the pair of first conductor pieces 5A, 5B, and a support 6. Note that, in the switching device 10, a state before the igniter 2 is actuated may be referred to as an “initial state.” The switching device 10 illustrated in FIG. 1 is in the initial state.

An installation target of the switching device 10 according to the first embodiment is not particularly limited. The switching device 10, in the event of an abnormality in a system including an electric circuit constituting, for example, an automobile, a household electric appliance, or a photovoltaic power generation system, or a battery (for example, a lithium ion battery) of the electric circuit, switches a first electric circuit, which is a predetermined electric circuit, from an interrupted state to a conductive state, preventing failure caused by excessive current or the like. Further, a configuration and an application of the first electric circuit in the present disclosure are not particularly limited. For example, the first electric circuit may be configured as a short circuit that intentionally short-circuits a current by switching to a conductive state for the purpose of releasing an electric charge accumulated in a circuit or a component to be protected. Further, the first electric circuit may be configured to, for example, bypass a failed location by being switched to a conductive state when any of the circuits constituting electric equipment, such as a semiconductor element or a battery cell, fails.

### Housing

The housing 1 is an outer shell member that accommodates various components and elements constituting the switching device 10. The housing 1 includes a top holder 11 and a housing body 12 provided below the top holder 11.

The top holder 11 is made of metal, for example, and as illustrated in FIG. 1, includes an attachment portion 111 having a tubular space shape extending in the vertical direction, and a flange portion 112 extending outward in a radial direction from a lower end portion of the attachment portion 111. An upper end of the attachment portion 111 is an open end, and the igniter 2 is attached to an inner side of the attachment portion 111, airtightly closing the open end.

The housing body 12 is an outer shell member formed from an insulating member such as a synthetic resin, for example. For example, the housing body 12 may be formed from nylon, which is a type of polyamide synthetic resin. The housing body 12 according to the first embodiment includes a top housing 121, a middle housing 122, and a bottom housing 123. The top housing 121 is formed in a tubular space shape extending in the vertical direction, and an upper end portion thereof is joined to the flange portion 112 of the top holder 11. The middle housing 122 is formed in a plate shape extending in the width direction, and is joined to a lower end portion of the top housing 121 with the pair of first conductor pieces 5A, 5B interposed therebetween. The middle housing 122 is formed with a through-hole 122a through which a protruding portion 62 of the support 6 described below passes. The bottom housing 123 is formed in a plate shape extending in the width direction and is joined to a lower surface of the middle housing 122. A groove portion 123a in which a base portion 61 of the support 6 described below is accommodated is formed in an upper surface of the bottom housing 123.

As illustrated in FIG. 1, a space inside the top holder 11 and a space inside the top housing 121 are continuous, forming the tubular space 3 extending in one direction (vertical direction in this example) in the housing 1. Note that, in the example illustrated in FIG. 1, the housing 1 is configured by combining the top holder 11, the top housing 121, the middle housing 122, and the bottom housing 123, but the technology of the present disclosure is not particularly limited to this mode.

Here, P1 in FIG. 1 denotes a predetermined first position in the extending direction of the tubular space 3 (that is, axial direction of the tubular space 3, which is the vertical direction in this example). The first position P1 is a position below the igniter 2. Further, P2 in FIG. 1 denotes a predetermined second position below the first position P1 in the extending direction of the tubular space 3. As illustrated in FIG. 1, an inner wall 3a defining the tubular space 3 is formed in a tapered shape, and therefore the tubular space 3 is formed decreasing in width toward the lower side. More specifically, the tubular space 3 is formed decreasing in width from the first position P1 toward the second position P2.

### Igniter

The igniter 2 is an ignition device that releases a combustion gas into the tubular space 3 upon actuation, and includes an ignition portion that accommodates an ignition charge in a cup body, for example. The igniter 2 can be formed by, for example, an electric igniter. The ignition charge accommodated in the ignition portion of the igniter 2 is not particularly limited and, for example, zirconium-potassium perchlorate (ZPP), zirconium-tungsten-potassium perchlorate (ZWPP), titanium hydride-potassium perchlorate (THPP), or lead tricinate may be adopted. Further, the igniter 2 may have a conduction pin (not illustrated) connected to a connector of an external power supply, and may ignite the ignition charge by an actuating current supplied from the external power supply to the electro-conductive pin. This type of electric igniter is known and, for example, an electric igniter provided in an inflator of an airbag device can be suitably adopted. As illustrated in FIG. 1, the igniter 2 is provided in the housing 1 with the ignition portion facing the inside of the tubular space 3. The igniter 2 releases the combustion gas generated by combustion of the ignition charge upon actuation into the tubular space 3.

### Projectile

The projectile 4 is formed by, for example, a metal piece having conductivity. As illustrated in FIG. 1, the projectile 4 is accommodated in the tubular space 3 of the housing 1. The projectile 4 is positioned at the first position P1 of the tubular space 3 in an initial state before actuation of the igniter 2. As described in detail below, upon actuation of the igniter 2, the projectile 4 is projected in a predetermined projecting direction along the extending direction of the tubular space 3 by energy of the combustion gas released from the igniter 2 into the tubular space 3. In the present embodiment, the projecting direction is set as downward in the vertical direction. Further, the projectile 4 may also be referred to as a “bullet.”

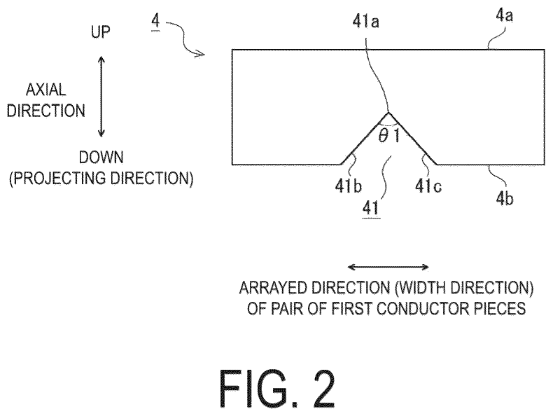

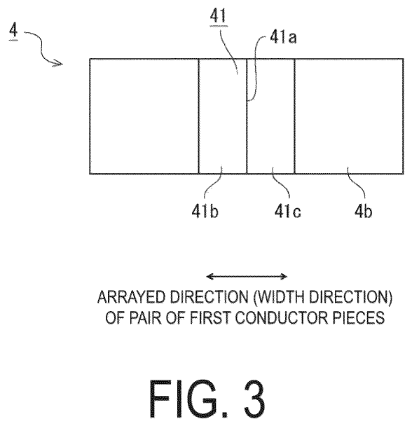

FIG. 2 is a front view of the projectile 4 according to the first embodiment. FIG. 3 is a bottom view of the projectile 4 according to the first embodiment. As illustrated in FIG. 1 to FIG. 3, the projectile 4 according to the first embodiment is formed in a plate shape extending in the width direction. An upper end surface 4a of the projectile 4 faces the ignition portion of the igniter 2. Therefore, the upper end surface 4a of the projectile 4 is formed as a pressure-receiving surface that receives energy generated by actuation of the igniter 2 (pressure of the combustion gas released from the igniter 2). When the igniter 2 is actuated, the projectile 4 is projected in the projecting direction by the energy (pressure) of the combustion gas received by the pressure-receiving surface. Further, a recessed portion 41 is formed in a lower end surface 4b that is an end surface of the projectile 4 on the projecting direction side. The recessed portion 41 according to the present example is provided at a center of the lower end surface 4b in the arrayed direction. Here, reference sign 41a in FIG. 2 denotes a most recessed portion (bottom portion) of the recessed portion 41. As illustrated in FIG. 2, the recessed portion 41 is formed in a triangular cross-sectional shape, increasing in width in the arrayed direction gradually from the bottom portion 41a in the projecting direction. The recessed portion 41 is formed by a pair of inclined surfaces 41b, 41c that are inclined, widening in the projecting direction. Here, a spread angle of the recessed portion 41 is θ1. The spread angle θ1 is an angle formed by the pair of inclined surfaces 41b, 41c.

Further, the projectile 4 has conductivity. The projectile 4 can be formed from a metal such as copper (Cu), for example. However, the material of the projectile 4 is not particularly limited as long as the material is a conductor. The projectile 4 may be formed from a metal other than copper, or may be formed from an alloy of copper and another metal.

As illustrated in FIG. 1, the projectile 4 is fitted to the inner wall 3a of the tubular space 3. Here, as described above, the inner wall 3a of the tubular space 3 is formed in a tapered shape, decreasing the width (that is, narrowing) of the tubular space 3 in the projecting direction. Therefore, the inner wall 3a of the tubular space 3 acts as resistance, suppressing movement of the projectile 4 on the projecting direction side as long as the igniter 2 is not actuated. Thus, in the initial state before actuation of the igniter 2, the projectile 4 is positioned at the first position P1 of the tubular space 3.

### First Conductor Pieces

The pair of first conductor pieces 5A, 5B illustrated in FIG. 1 are components constituting the switching device 10, and are conductors for forming, in cooperation with each other, part of a predetermined first electric circuit in an electric device to which the switching device 10 is applied. The pair of first conductor pieces 5A, 5B are also referred to as bus bars. The pair of first conductor pieces 5A, 5B can be formed from a metal such as copper (Cu), for example. However, the material of the pair of first conductor pieces 5A, 5B is not particularly limited as long as the material is a conductor. The pair of first conductor pieces 5A, 5B may be formed from a metal other than copper, or may be formed from an alloy of copper and another metal. Note that examples of metals other than copper that can be included in the pair of first conductor pieces 5A, 5B include manganese (Mn), nickel (Ni), and platinum (Pt). The first electric circuit is formed including the pair of first conductor pieces 5A, 5B and a circuit component in another electric device.

As illustrated in FIG. 1, the pair of first conductor pieces 5A, 5B are provided inserted, in a spaced apart state, into tubular space 3 at the second position P2. As described above, the second position P2 is defined as a position below (closer to the projecting direction side than) the first position P1 where the projectile 4 is positioned. The pair of first conductor pieces 5A, 5B are held by the housing 1 in a state of being vertically interposed between the top housing 121 and the middle housing 122, forming a posture of extending in the arrayed direction. Each of the first conductor pieces 5A, 5B includes an inner end portion 51 inserted into the tubular space 3 and an outer end portion 52 exposed to the outside of the housing 1. Other conductors (for example, lead wires) forming the first electric circuit are connected to the outer end portions 52 of each of the first conductor pieces 5A, 5B.

As illustrated in FIG. 1, in the initial state before actuation of the igniter 2, the pair of first conductor pieces 5A, 5B configured as described above are spaced apart, and thus the first electric circuit is maintained in an interrupted state. On the other hand, although operation of the switching device 10 will be described below, when the igniter 2 is actuated, the pair of first conductor pieces 5A, 5B are electrically connected to each other via the projectile 4, and the first electric circuit is switched from the interrupted state to the conductive state. Accordingly, in the switching device 10 after actuation, the projectile 4 can be said to also function as a circuit component constituting the first electric circuit.

### Support

The support 6 illustrated in FIG. 1 is a member that receives, at the second position P2, the projectile 4 projected by actuation of the igniter 2, and causes the projectile 4 to be deformed, thereby engaging the projectile 4 with the pair of first conductor pieces 5A, 5B. The support 6 can be formed from, for example, a metal having higher strength (hardness) than that of the projectile 4. The material of the support 6 is not particularly limited. For example, in a case in which the material of the projectile 4 is copper (Cu), stainless steel such as SUS having higher hardness than copper can be adopted.

As illustrated in FIG. 1, the support 6 is disposed below (that is, closer to the projecting direction side than) the first position P1 at which the projectile 4 is positioned. In the present example, the support 6 is disposed closer to the projecting direction side than the second position P2. However, the technology of the present disclosure is not limited to this mode. The support may be disposed at a position closer to the projecting direction side than the first position, or may be disposed at the second position or at a position closer to the side opposite to the projecting direction (upper side in the present example) than the second position.

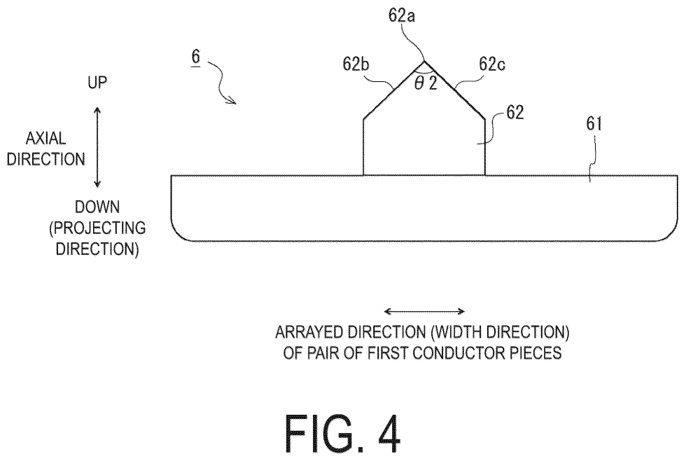

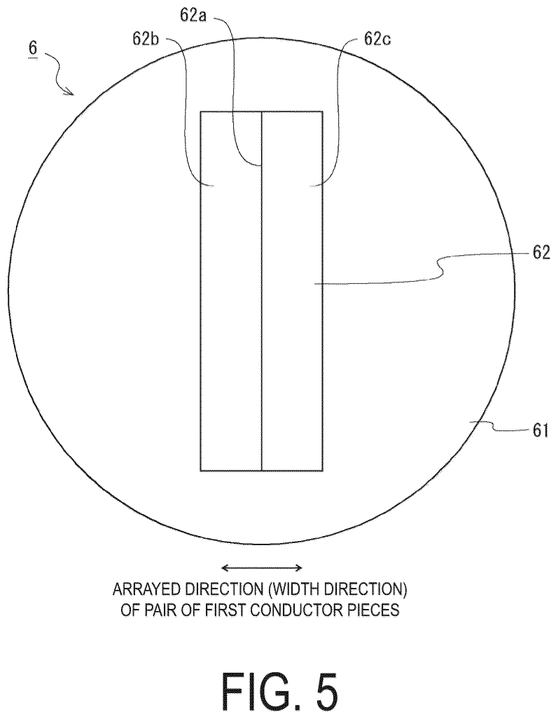

FIG. 4 is a front view of the support 6 according to the first embodiment. FIG. 5 is a top view of the support 6 according to the first embodiment. As illustrated in FIG. 1, FIG. 4, and FIG. 5, the support 6 according to the first embodiment includes the base portion 61 and the protruding portion 62. The base portion 61 is formed in a disk shape orthogonal to the vertical direction. The protruding portion 62 protrudes from an upper surface of the base portion 61 toward the upper side (that is, the side opposite to the projecting direction). The protruding portion 62 according to the present example is provided at a center of the base portion 61 in the arrayed direction. Here, reference sign 62a in FIG. 4 denotes a distal end portion (top portion) of the protruding portion 62. As illustrated in FIG. 4, the protruding portion 62 is formed in a triangular cross-sectional shape, increasing in width in the arrayed direction gradually from the distal end portion 62a in the projecting direction. The protruding portion 62 is formed by a pair of inclined surfaces 62b, 62c that are inclined, increasing in width in the projecting direction. Here, a spread angle of the protruding portion 62 is θ2. The spread angle θ2 is an angle formed by the pair of inclined surfaces 62b, 62c. In the present embodiment, the spread angle θ2 of the protruding portion 62 of the support 6 is set larger than the spread angle θ1 of the recessed portion 41 of the projectile 4.

As illustrated in FIG. 1, the support 6 is held by the housing 1 with the base portion 61 being accommodated in the groove portion 123a of the bottom housing 123 and the protruding portion 62 being inserted through the through-hole 122a of the middle housing 122 and protruding into the tubular space 3. Accordingly, the protruding portion 62 protrudes toward the side opposite to the projecting direction at a lower end portion of the tubular space 3, that is, at an end portion of the tubular space 3 on the projecting direction side. Further, as illustrated in FIG. 1, the protruding portion 62 is positioned between the pair of first conductor pieces 5A, 5B in the arrayed direction and faces the recessed portion 41 of the projectile 4.

### Operation

Next, operation of the switching device 10 will be described. Before actuation, the switching device 10 is in the initial state illustrated in FIG. 1 as described above. In the initial state illustrated in FIG. 1, the pair of first conductor pieces 5A, 5B are spaced apart, and thus the first electric circuit partially formed by the pair of first conductor pieces 5A, 5B is maintained in an interrupted state. Furthermore, in the initial state, the projectile 4 is positioned at the first position P1 of the tubular space 3 in a state of being fitted to the inner wall 3a of the tubular space 3.

For example, when an abnormality occurs in an electric device to which the switching device 10 is applied, the switching device 10 is actuated to protect the electric device and urgently switches the first electric circuit from the interrupted state to a conductive state.

Here, the switching device 10 according to the first embodiment further includes an abnormality detection sensor (not illustrated) configured to detect an abnormal state of the electric device (a vehicle, power generation equipment, or power storage equipment, for example) in which the switching device 10 is installed, and a control unit (not illustrated) configured to control actuation of the igniter 2. The abnormality detection sensor may detect an abnormal state such as excessive current on the basis of, for example, a current flowing through a circuit to be protected in the electric device. Further, the abnormality detection sensor may be, for example, an impact sensor, a temperature sensor, an acceleration sensor, a vibration sensor, or the like, and may detect an abnormal state such as an accident or fire on the basis of an impact, a temperature, acceleration, or vibration in a device such as a vehicle. The control unit of the switching device 10 is a computer capable of performing a predetermined function by executing a predetermined control program, for example. The predetermined function of the control unit may be realized by corresponding hardware. For example, when excessive current flows through a circuit to be protected in an electric device in which the switching device 10 is installed, this excessive current is detected by the abnormality detection sensor. Abnormality information regarding the detected abnormal current is passed from the abnormality detection sensor to the control unit. For example, the control unit is energized from an external power supply (not illustrated) connected to electro-conductive pins of the igniter 2 and actuates the igniter 2 on the basis of the current value detected by the abnormality detection sensor. Here, the excessive current may be defined by a current value that exceeds a predetermined threshold value set for protection of the electric circuit to be protected. Note that the abnormality detection sensor and the control unit described above need not be included in the components of the switching device 10, and may be included in a device separate from the switching device 10, for example. Further, the abnormality detection sensor and the control unit described above are not essential components of the switching device 10.

When the igniter 2 of the switching device 10 is actuated, the combustion gas is released from the igniter 2 into the tubular space 3. Then, the projectile 4 receives the energy (pressure) of the combustion gas at the upper end surface 4a. Then, the projectile 4 is projected in the projecting direction (downward) in the tubular space 3 by using, as a propulsive force, the energy of the combustion gas exceeding a drag received from the inner wall 3a of the tubular space 3.

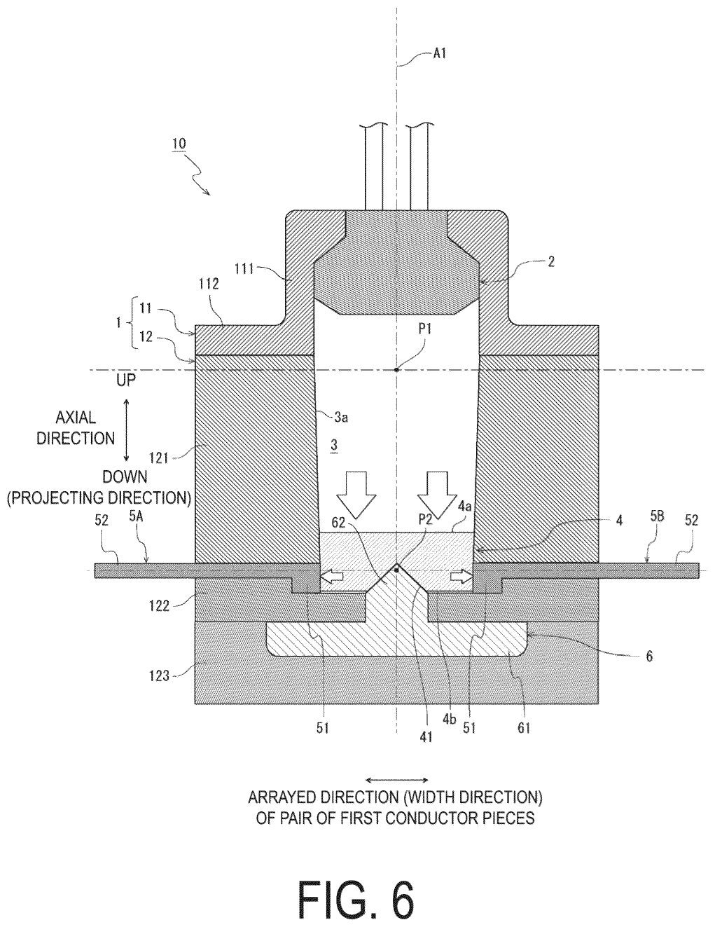

FIG. 6 is a vertical cross-sectional view illustrating the state after actuation of the switching device 10 according to the first embodiment. As illustrated in FIG. 6, the projectile 4 projected from the first position P1 by actuation of the igniter 2 is received by the support 6 at the second position P2. Here, the pair of first conductor pieces 5A, 5B are provided inserted at the second position P2 and positioned on opposite sides, sandwiching the projectile 4 received by the support 6. Therefore, the projected projectile 4 enters between the pair of first conductor pieces 5A, 5B. Further, the protruding portion 62 of the support 6 and the recessed portion 41 of the projectile 4 face each other, and thus the protruding portion 62 of the support 6 enters the recessed portion 41 of the projected projectile 4. Therefore, the protruding portion 62 of the support 6 collides with inner walls (inclined surfaces 41b, 41c) of the recessed portion 41. At this time, as described above, the spread angle θ2 of the protruding portion 62 of the support 6 is set larger than the spread angle θ1 of the recessed portion 41 of the projectile 4. Therefore, when the protruding portion 62 of the support 6 collides with the inner walls of the recessed portion 41, the projectile 4 is deformed by the protruding portion 62, pressing and expanding the recessed portion 41. As a result, the projectile 4 increases in width in the arrayed direction between the pair of first conductor pieces 5A, 5B, and the projectile 4 is sandwiched by the pair of first conductor pieces 5A, 5B. At this time, each of the pair of first conductor pieces 5A, 5B is pressed outward by a widening force of the projectile 4. Therefore, the projectile 4 is press-fitted between the pair of first conductor pieces 5A, 5B. As a result, the projectile 4 is engaged with (fixed to) the pair of first conductor pieces 5A, 5B in a state in which the projectile 4 and each of the pair of first conductor pieces 5A, 5B are in contact with each other.

When the projectile 4 and each of the pair of first conductor pieces 5A, 5B come into contact with each other, the pair of first conductor pieces 5A, 5B are electrically connected to each other via the projectile 4 having conductivity. As a result, the first electric circuit is switched from the interrupted state to the conductive state.

### Effects

As described above, the switching device 10 according to the first embodiment includes the housing 1; the igniter 2 provided in the housing 1 and configured to release a combustion gas upon actuation; the tubular space 3 formed in the housing 1 and extending in one direction; the projectile 4 having conductivity, positioned at the first position P1 in the tubular space 3 in an initial state before actuation of the igniter 2, and configured to be projected in a predetermined projecting direction along the tubular space 3 by energy of the combustion gas; the pair of first conductor pieces 5A, 5B provided inserted, in a spaced apart state, into the tubular space 3 at the second position P2 closer to the projecting direction side than the first position P1, and forming part of the first electric circuit in cooperation with each other; and the support 6 disposed closer to the projecting direction side than the first position P1 in the tubular space 3, and configured to receive, at the second position P2, the projectile 4 projected upon actuation of the igniter 2. Then, in the switching device 10 according to the first embodiment, when the igniter 2 is actuated and the projectile 4 is projected, the projectile 4 deforms by collision with the support 6, the projectile 4 and each of the pair of first conductor pieces 5A, 5B come into contact with each other, and the projectile 4 becomes engaged with the pair of first conductor pieces 5A, 5B, switching the first electric circuit from an interrupted state to a conductive state.

That is, the switching device 10 according to the first embodiment projects the projectile 4 having conductivity by utilizing the energy of the combustion gas generated by the ignition of the ignition charge in the igniter 2 as the energy source for actuating the switching device 10, and switches the electric circuit from the interrupted state to the conductive state by the projectile 4. By using a pyro-drive in which pyrotechnics are utilized as an actuation source of the switching device 10, it is possible to shorten the time required for switching the electric circuit as compared with, for example, an electromagnetic relay in the related art. As a result, it is possible to quickly protect the electric device in which the switching device 10 is installed and avoid failure.

Furthermore, the switching device 10 according to the first embodiment adopts a configuration in which, when the projectile 4 deforms by collision with the support 6, the projectile 4 and each of the pair of first conductor pieces 5A, 5B come into contact with each other, and the projectile 4 becomes engaged with the pair of first conductor pieces 5A, 5B. According to such a switching device 10, the projectile 4 received by the support 6 is engaged with the pair of first conductor pieces 5A, 5B, making it possible to suppress the return of the projectile 4 in the direction opposite to the projecting direction, that is, toward the first position P1 side, due to the collision when the projectile 4 is received by the support 6. Further, even in a case in which collision or vibration occurs in the switching device 10 after actuation, detachment of the projectile 4 from the pair of first conductor pieces 5A, 5B is suppressed. As a result, according to the switching device 10 of the first embodiment, it is possible to maintain the contact state between the projectile 4 and each of the pair of first conductor pieces 5A, 5B, and thus maintain the conductive state of the first electric circuit after actuation.

Further, the switching device 10 according to the first embodiment adopts a configuration in which the projectile 4 is deformed and the protruding portion 62 of the support 6 presses and expands the recessed portion 41, thereby increasing the projectile 4 in width in the arrayed direction of the pair of first conductor pieces 5A, 5B and press-fitting the projectile 4 between the pair of first conductor pieces 5A, 5B. This makes it possible to make the projectile 4 engage with the pair of first conductor pieces 5A, 5B. At this time, in the switching device 10 according to the first embodiment, the spread angle θ2 of the protruding portion 62 is set larger than the spread angle θ1 of the recessed portion 41, making it possible to press and expand the recessed portion 41 by the protruding portion 62.

Further, in the switching device 10 according to the first embodiment, the projectile 4 is fitted to the inner wall 3a of the tubular space 3, and the inner wall 3a of the tubular space 3 is formed decreasing the width of the tubular space 3 in the projecting direction. Thus, in the initial state before actuation of the igniter 2, it is possible to position the projectile 4 at the first position and suppress movement of the projectile 4 in the projecting direction before actuation of the igniter 2. Note that the technology of the present disclosure is not limited to this mode. For example, the projectile may be positioned by press-fitting the projectile into the inner wall of the tubular space.

### Modified Example of First Embodiment

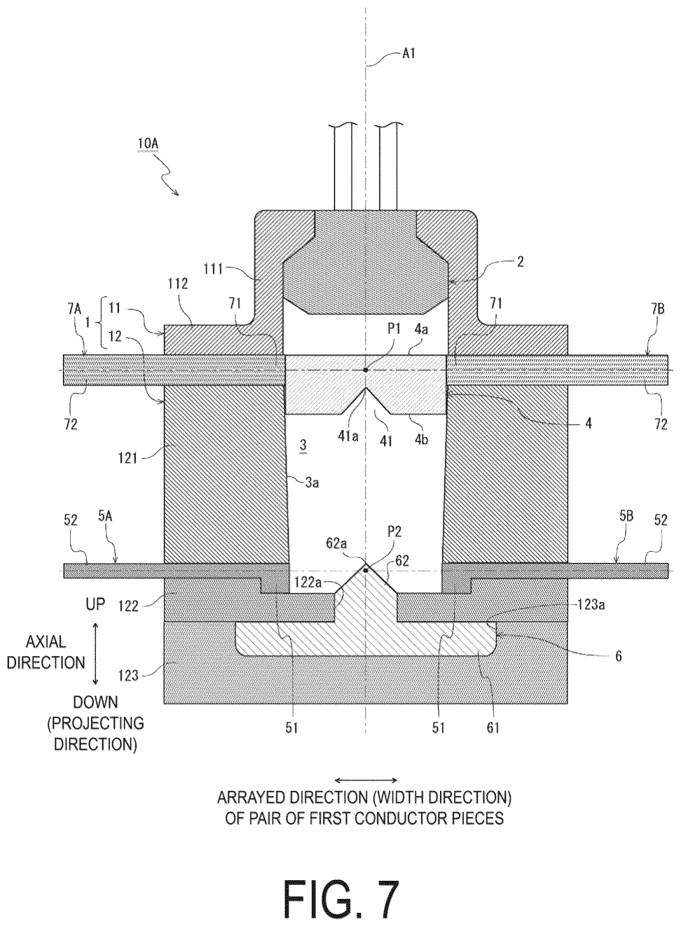

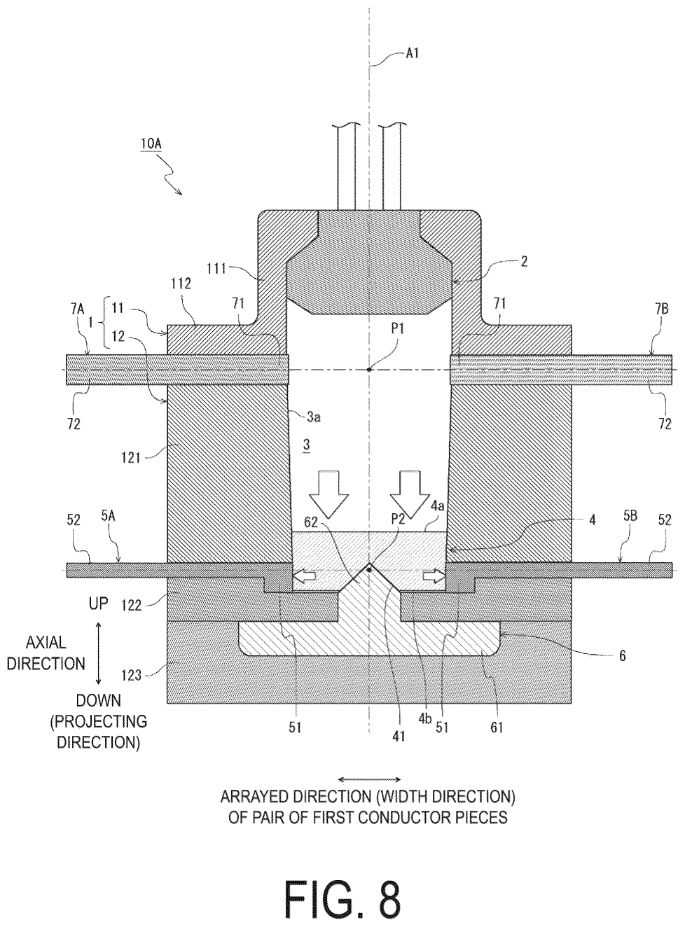

Below, a switching device 10A according to a modified example of the first embodiment will be described. In the description of the switching device 10A, description will be made with a focus on the differences from the switching device 10. Elements that are the same as those of the switching device 10 will be denoted using the same references signs, and detailed description thereof will be omitted. FIG. 7 is a vertical cross-sectional view for describing a state before actuation of the switching device 10A according to the modified example of the first embodiment. FIG. 8 is a vertical cross-sectional view for describing a state after actuation of the switching device 10A according to the modified example of the first embodiment. As illustrated in FIG. 7 and FIG. 8, the switching device 10A according to the modified example of the first embodiment differs from the switching device 10 described above in further including a pair of second conductor pieces denoted by reference signs 7A, 7B.

### Configuration

The switching device 10A according to the modified example of the first embodiment protects an electric device, which is an installation target, when an abnormality occurs in the device by urgently switching a predetermined second electric circuit from a conductive state to an interrupted state and urgently switching a predetermined first electric circuit from an interrupted state to a conductive state. Note that the installation target of the switching device 10A according to the modified example of the first embodiment is not particularly limited. Further, a configuration and an application of the second electric circuit in the present disclosure are not particularly limited. The second electric circuit may be, for example, a circuit to be protected in a target electric device in which the switching device 10A is installed. For example, the installation target of the switching device 10A may be an automobile, and the second electric circuit may be a circuit for supplying power from a battery of the automobile to an external component. For example, in a case in which a unit that controls the battery fails, the switching device 10A according to the modified example of the first embodiment may be configured to switch the second electric circuit from the conductive state to the interrupted state to interrupt the power supply from the battery to the outside, thereby suppressing failure of the external component due to excessive current, and switch the first electric circuit from the interrupted state to the conductive state to release a charge accumulated in the second electric circuit from the first electric circuit, thereby protecting the second electric circuit.

The pair of second conductor pieces 7A, 7B illustrated in FIG. 7 are components constituting the switching device 10A, and are conductors for forming, in cooperation with each other, part of a predetermined second electric circuit in an electric device to which the switching device 10A is applied. The pair of second conductor pieces 7A, 7B are also referred as bus bars. The second electric circuit is formed including the pair of second conductor pieces 7A, 7B and a circuit component in another electric device. A material of the pair of second conductor pieces 7A, 7B is not particularly limited as long as the material is a conductor, and the material used for the first conductor pieces 5A, 5B described above (for example, copper or the like) can be suitably adopted.

As illustrated in FIG. 7, the pair of second conductor pieces 7A, 7B are provided inserted, in a spaced apart state, into tubular space 3 at the first position P1. As described above, the first position P1 is a position where the projectile 4 is positioned. The pair of second conductor pieces 7A, 7B are held by the housing 1, forming a posture extending in the arrayed direction. Each of the pair of second conductor pieces 7A, 7B includes an inner end portion 71 inserted into the tubular space 3 and an outer end portion 72 exposed to the outside of the housing 1. Other conductors (for example, lead wires) forming the second electric circuit are connected to the outer end portions 72 of each of the second conductor pieces 7A, 7B.

As illustrated in FIG. 7, in the initial state before actuation of the igniter 2, the projectile 4 positioned at the first position P1 is interposed between the pair of second conductor pieces 7A, 7B. At this time, the projectile 4 having conductivity is in contact with the inner end portions 71 of each of the pair of second conductor pieces 7A, 7B. Therefore, in the initial state, the pair of second conductor pieces 7A, 7B are electrically connected via the projectile 4.

Next, operation of the switching device 10A according to the modified example of the first embodiment will be described. In the initial state illustrated in FIG. 7, the pair of first conductor pieces 5A, 5B are spaced apart, and thus the first electric circuit is maintained in an interrupted state. On the other hand, in the initial state, the pair of second conductor pieces 7A, 7B are electrically connected to each other via the projectile 4, and thus the second electric circuit is in a conductive state. That is, in the switching device 10A in the initial state, the projectile 4 can be said to also function as a circuit component constituting the second electric circuit.

For example, when an abnormality occurs in an electric device to which the switching device 10A is applied, the switching device 10A is actuated to protect the electric device and urgently switches the first electric circuit from the interrupted state to a conductive state and the second electric circuit from the conductive state to an interrupted state.

When the igniter 2 is actuated, the projectile 4 receiving the energy (pressure) of the combustion gas at the upper end surface 4a is projected in the projecting direction (downward) in the tubular space 3 by using the energy of the combustion gas as a propulsive force. The projectile 4 is moved from the first position P1 by actuation of the igniter 2, resulting in non-contact between the projectile 4 and each of the pair of second conductor pieces 7A, 7B, as illustrated in FIG. 8. Accordingly, the electrical connection between the pair of second conductor pieces 7A, 7B via the projectile 4 is disconnected, and the second electric circuit is switched from the conductive state to the interrupted state. Then, as with the switching device 10, the projectile 4 received at the second position P2 by the support 6 and each of the pair of first conductor pieces 5A, 5B come into contact with each other, switching the first electric circuit from the interrupted state to the conductive state. Further, in the switching device 10A, as with the switching device 10, the projectile 4 deformed by the collision with the support 6 is engaged with the pair of first conductor pieces 5A, 5B, and thus the conductive state of the first electric circuit is maintained after actuation.

### Effects

As described above, the switching device 10A according to the modified example of the first embodiment utilizes the energy of the combustion gas generated by actuation of the igniter 2 to urgently switch the second electric circuit from the conductive state to the interrupted state and to urgently switch the first electric circuit from the interrupted state to the conductive state. That is, the switching device 10A can switch the electric circuit that is to be in the conductive state from the second electric circuit to the first electric circuit by a pyro-drive. By using a pyro-drive in which pyrotechnics are utilized as an actuation source of the switching device 10A, it is possible to shorten the time required for switching the electric circuit as compared with, for example, an electromagnetic relay in the related art. This makes it possible to quickly protect the electric device in which the switching device 10A is installed and to avoid failure. Further, the switching device 10A adopts a configuration in which the projectile 4 that electrically connects the pair of second conductor pieces 7A, 7B is projected and the projected projectile 4 electrically connects the pair of first conductor pieces 5A, 5B, and thus the switching of the second electric circuit from the conductive state to the interrupted state and the switching of the first electric circuit from the interrupted state to the conductive state can be realized by one actuation of the igniter 2.

Note that, in the switching device 10A according to the modified example of the first embodiment, the projectile 4 and each of the pair of second conductor pieces 7A, 7B are formed as separate members. However, the technology of the present disclosure is not limited thereto. For example, the projectile and each of the pair of second conductor pieces may be formed as an integral member (one member). In the switching device 10A, as in a modified example of a second embodiment described below, the projectile 4 and each of the pair of second conductor pieces 7A, 7B may be conductor components formed as one member in the initial state before actuation of the igniter 2. Then, when the igniter 2 is actuated, the projectile 4 may be separated from the conductor components by the pressure of the combustion gas and moved in the projecting direction, disconnecting the connection between the pair of second conductor pieces 7A, 7B via the projectile 4.

### Second Embodiment

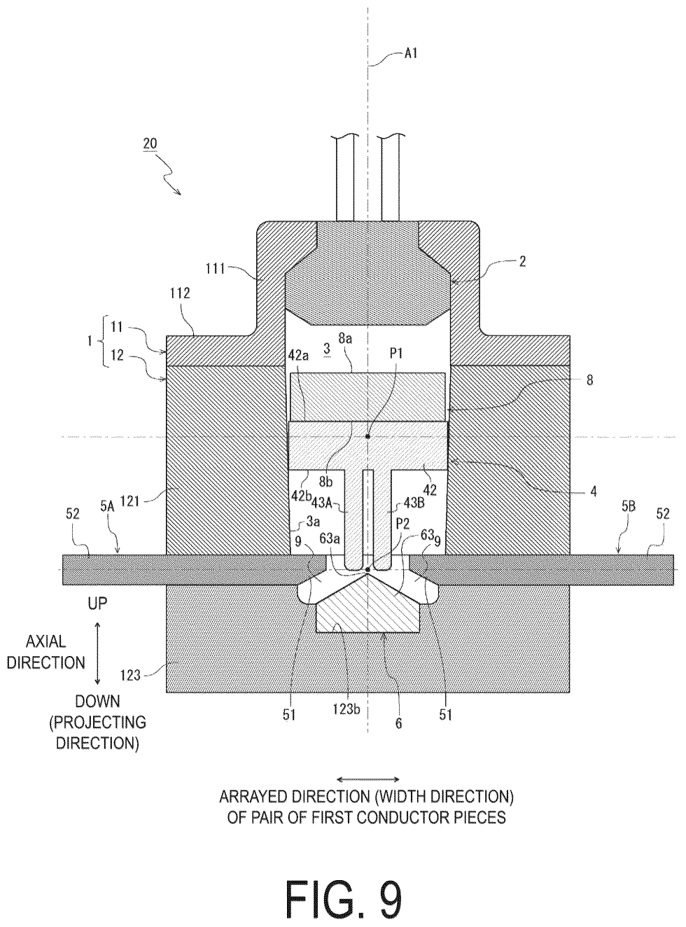

Next, a switching device 20 according to the second embodiment will be described. Here, description will be made with a focus on the differences from the first embodiment. Configurations common to those of the switching device 10 according to the first embodiment will be denoted using the same references signs, and detailed description thereof will be omitted. FIG. 9 is a vertical cross-sectional view for describing a state before actuation of the switching device 20 according to the second embodiment.

### Configuration

As illustrated in FIG. 9, the switching device 20 according to the second embodiment differs from the switching device 10 according to the first embodiment in further including a piston denoted by reference sign 8. Further, the projectile 4 according to the second embodiment differs from the projectile 4 according to the first embodiment in including a pair of extending portions denoted by reference signs 43A, 43B. Further, the support 6 according to the second embodiment differs from the support 6 according to the first embodiment in that the base portion 61 is not provided. Further, the pair of first conductor pieces 5A, 5B according to the second embodiment differ from the pair of first conductor pieces 5A, 5B according to the first embodiment in the shape of the inner end portions 51.

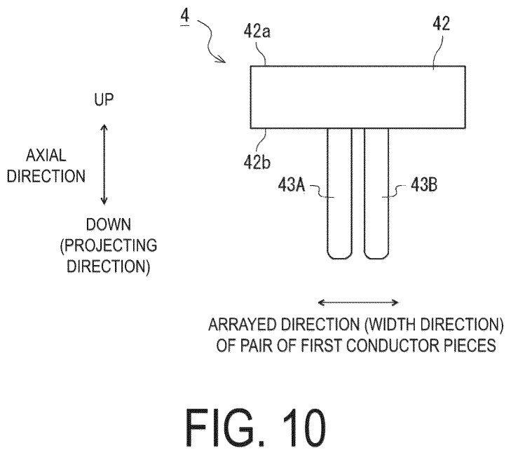

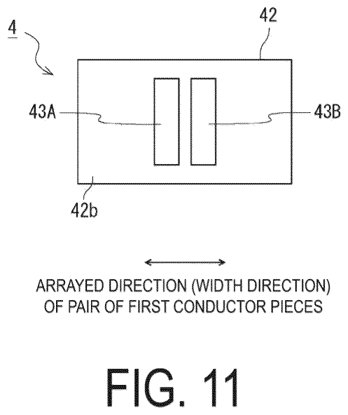

FIG. 10 is a front view of the projectile 4 according to the second embodiment. FIG. 11 is a bottom view of the projectile 4 according to the second embodiment. As illustrated in FIG. 9 to FIG. 11, the projectile 4 according to the second embodiment includes a main body portion 42 and the pair of extending portions 43A, 43B. The main body portion 42 is formed in a plate shape extending in the width direction. The main body portion 42 is positioned at the first position P1 of the tubular space 3 in an initial state before actuation of the igniter 2. The pair of extending portions 43A, 43B are provided side by side in the arrayed direction of the pair of first conductor pieces 5A, 5B, and extend in the projecting direction from a lower end surface 42b of the main body portion 42. The pair of extending portions 43A, 43B according to the present example are provided at a center of the main body portion 42 in the arrayed direction. Further, the pair of extending portions 43A, 43B are formed in a piece shape (plate shape) orthogonal to the arrayed direction. However, in the technology according to the present disclosure, the shape of the pair of extending portions is not limited thereto. The pair of extending portions may have, for example, a rod shape.

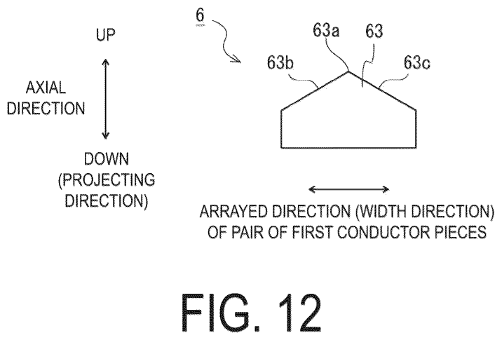

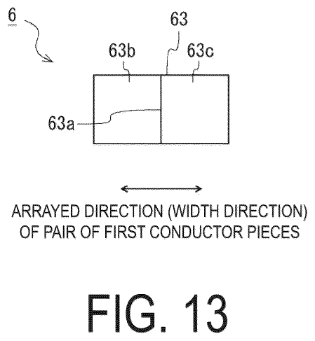

FIG. 12 is a front view of the support 6 according to the second embodiment. FIG. 13 is a bottom view of the support 6 according to the second embodiment. As illustrated in FIG. 9, FIG. 12, and FIG. 13, the support 6 according to the second embodiment includes a protruding portion 63 that protrudes toward the upper side (that is, the side opposite to the projecting direction). Here, reference sign 63a in FIG. 12 denotes a distal end area (top portion) of the protruding portion 63. As illustrated in FIG. 12, the protruding portion 63 is formed in a triangular cross-sectional shape, increasing in width in the arrayed direction gradually from the distal end portion 63a in the projecting direction. The protruding portion 63 is formed by a pair of inclined surfaces 63b, 63c that are inclined, widening in the projecting direction.

As illustrated in FIG. 9, the support 6 according to the second embodiment is accommodated in a groove portion 123b formed in the bottom housing 123, and is held by the housing 1 in a state in which the protruding portion 63 protrudes into the tubular space 3. Thus, the protruding portion 63 protrudes toward the side opposite to the projecting direction at the end portion of the tubular space 3 on the projecting direction side. Further, as illustrated in FIG. 9, the protruding portion 63 is positioned between the pair of first conductor pieces 5A, 5B in the arrayed direction. Furthermore, the distal end portion 63a of the protruding portion 63 is positioned between the pair of extending portions 43A, 43B of the projectile 4 in the arrayed direction.

The piston 8 is a member that pushes the projectile 4 in the projecting direction and thus the projectile 4 is more reliably deformed upon actuation of the igniter 2. As illustrated in FIG. 9, the piston 8 is disposed in the tubular space 3, interposedly between the igniter 2 and the projectile 4. The piston 8 is formed in a plate shape extending in the width direction. However, the shape of the piston according to the present disclosure is not limited thereto. An upper end surface 8a of the piston 8 faces the ignition portion of the igniter 2. Therefore, the upper end surface 8a of the piston 8 is formed as a pressure-receiving surface that receives energy generated by the actuation of the igniter 2 (pressure of the combustion gas released from the igniter 2). A lower end surface 8b of the piston 8 faces the upper end surface 42a of the main body portion 42 of the projectile 4. When the igniter 2 is actuated, the piston 8 is projected in the projecting direction by the energy (pressure) of the combustion gas received by the pressure-receiving surface. At this time, the lower end surface 8b of the piston 8 presses the upper end surface 42a of the projectile 4.

As with the support 6, the piston 8 can be formed from, for example, a metal having higher strength (hardness) than that of the projectile 4. A material of the piston 8 is not limited. For example, in a case in which the material of the projectile 4 is copper (Cu), stainless steel such as SUS having higher hardness than copper can be used.

As illustrated in FIG. 9, the inner end portion 51 of the first conductor piece 5A according to the second embodiment is formed to include an inclined surface facing the inclined surface 63b of the protruding portion 63 of the support 6. Similarly, the inner end portion 51 of the first conductor piece 5B according to the second embodiment is formed to include an inclined surface facing the inclined surface 63c of the protruding portion 63 of the support 6. Thus, in the switching device 20 according to the second embodiment, an accommodation space denoted by reference sign 9 is formed between the protruding portion 63 of the support 6 and each of the pair of first conductor pieces 5A, 5B. A capacity of the accommodation space 9 is set, facilitating accommodation of the extending portion 43A and the extending portion 43B.

### Operation

Next, operation of the switching device 20 according to the second embodiment will be described. In the initial state illustrated in FIG. 9, the pair of first conductor pieces 5A, 5B are spaced apart, and thus the first electric circuit is maintained in an interrupted state. Further, in the initial state, the protruding portion 63 of the support 6 and the pair of extending portions 43A, 43B of the projectile 4 are separated from each other. Note that, as long as the first electric circuit is maintained in the interrupted state, the protruding portion 63 and the pair of extending portions 43A, 43B may be in contact with each other in the initial state.

When the igniter 2 is actuated, the piston 8 receiving the energy (pressure) of the combustion gas at the upper end surface 8a is projected in the projecting direction (downward) in the tubular space 3 by using the energy of the combustion gas as a propulsive force. At this time, the lower end surface 8b of the piston 8 presses the upper end surface 42a of the projectile 4, transmitting the energy of the combustion gas to the projectile 4 via the piston 8. The projectile 4 is projected in the projecting direction in the tubular space 3 while being pushed by the piston 8 by using, as a propulsive force, the energy of the combustion gas exceeding the drag received from the inner wall 3a of the tubular space 3.

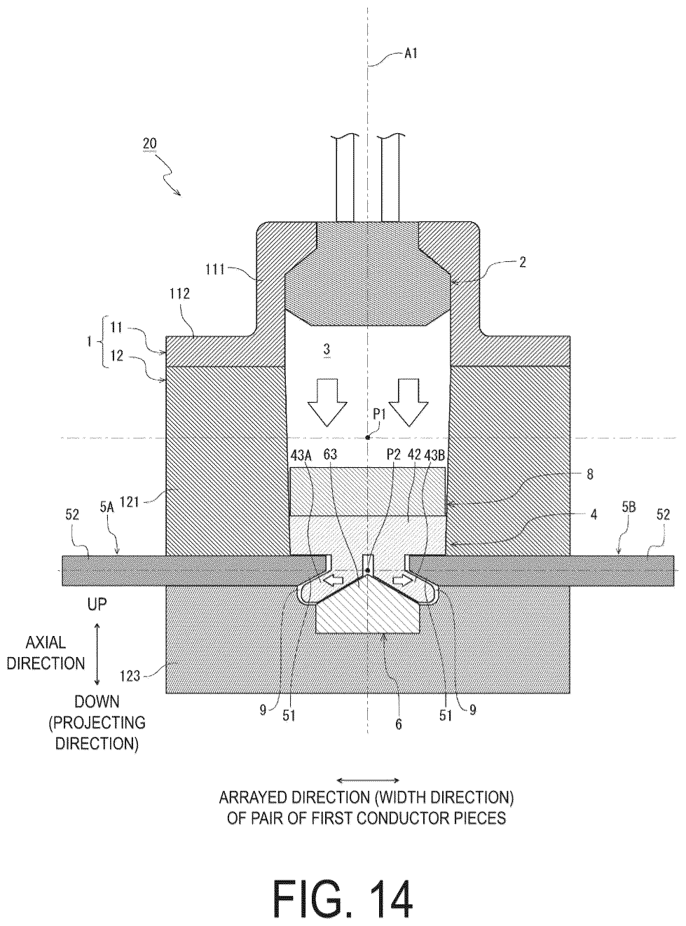

FIG. 14 is a vertical cross-sectional view illustrating a state after actuation of the switching device 20 according to the second embodiment. As illustrated in FIG. 14, the projectile 4 projected from the first position P1 by actuation of the igniter 2 is received by the support 6 at the second position P2. Here, the pair of first conductor pieces 5A, 5B are provided inserted at the second position P2 and positioned on opposite sides, sandwiching the projectile 4 received by the support 6. Therefore, the pair of extending portions 43A, 43B of the projected projectile 4 enter between the pair of first conductor pieces 5A, 5B. Further, the distal end portion 63a of the protruding portion 63 of the support 6 is positioned between the pair of extending portions 43A, 43B of the projectile 4 in the arrayed direction, resulting in the protruding portion 63 of the support 6 entering between the pair of extending portions 43A, 43B of the projected projectile 4. Therefore, the protruding portion 63 of the support 6 collides with distal ends of the pair of extending portions 43A, 43B. At this time, as described above, the protruding portion 63 is formed increasing in width in the arrayed direction from the distal end portion 63a in the projecting direction. Therefore, when the protruding portion 62 of the support 6 collides with the distal ends of the pair of extending portions 43A, 43B, the pair of extending portions 43A, 43B deform along the protruding portion 63, as illustrated in FIG. 14. More specifically, the pair of extending portions 43A, 43B are bent outward, pressing and expanding a gap therebetween. At this time, the pair of extending portions 43A, 43B bent by the protruding portion 63 are accommodated in the accommodation space 9 formed between the protruding portion 63 and each of the pair of first conductor pieces 5A, 5B. Accordingly, the first conductor piece 5A is sandwiched between the extending portion 43A and the main body portion 42 of the projectile 4, and the first conductor piece 5B is sandwiched between the extending portion 43B and the main body portion 42. As a result, as illustrated in FIG. 14, the projectile 4 is engaged with (fixed to) the pair of first conductor pieces 5A, 5B in a state in which the projectile 4 and each of the pair of first conductor pieces 5A, 5B are in contact with each other.

When the projectile 4 and each of the pair of first conductor pieces 5A, 5B come into contact with each other, the pair of first conductor pieces 5A, 5B are electrically connected to each other via the projectile 4 having conductivity. As a result, the first electric circuit is switched from the interrupted state to the conductive state.

### Effects

With the switching device 20 according to the second embodiment as well, the same effects as those of the switching device 10 according to the first embodiment can be achieved. That is, by using a pyro-drive in which pyrotechnics are utilized as an actuation source of the switching device 20, it is possible to shorten the time required for switching the electric circuit. Furthermore, the projectile 4 deformed by the collision with the support 6 is engaged with the pair of first conductor pieces 5A, 5B, making it possible to maintain the conductive state of the first electric circuit after actuation.

Further, the switching device 20 according to the second embodiment adopts a configuration in which the protruding portion 62 of the support 6 deforms the projectile 4, bending the pair of extending portions 43A, 43B outward. Then, the switching device 20 adopts a configuration in which, when the projectile 4 is deformed, one of the pair of first conductor pieces 5A, 5B (first conductor piece 5A) is sandwiched between one of the pair of extending portions 43A, 43B (extending portion 43A) and the main body portion 42, and the other of the pair of first conductor pieces 5A, 5B (first conductor piece 5B) is sandwiched between the other of the pair of extending portions 43A, 43B (extending portion 43B) and the main body portion 42. This makes it possible to make the projectile 4 engage with the pair of first conductor pieces 5A, 5B. Further, in the switching device 20 according to the second embodiment, the accommodation space 9 in which the pair of extending portions 43A, 43B bent by the protruding portion 63 are accommodated is formed between the protruding portion 63 of the support 6 and each of the pair of first conductor pieces 5A, 5B, making it possible for the protruding portion 62 of the support 6 to bend the pair of extending portions 43A, 43B outward. Note that, in the technology according to the present disclosure, three or more extending portions may be provided to the projectile. That is, in a mode in which the projectile is engaged with the pair of first conductor pieces by bending the extending portions, the projectile need only have at least one pair of extending portions (two extending portions).

Further, the switching device 20 according to the second embodiment includes the piston 8 disposed in the tubular space 3, interposedly between the igniter 2 and the projectile 4, and configured to be projected in the projecting direction by the energy of the combustion gas. According to this configuration, the projectile 4 is pushed in the projecting direction by the piston 8 upon actuation of the igniter 2, making it possible to more reliably deform the projectile 4. Note that the switching device 20 according to the second embodiment need not include the piston 8. The switching device 20 may not include the piston 8 and, as with the switching device 10 according to the first embodiment, may adopt a configuration in which the projectile 4 is projected by directly receiving the pressure of the combustion gas.

### Modified Example of Second Embodiment

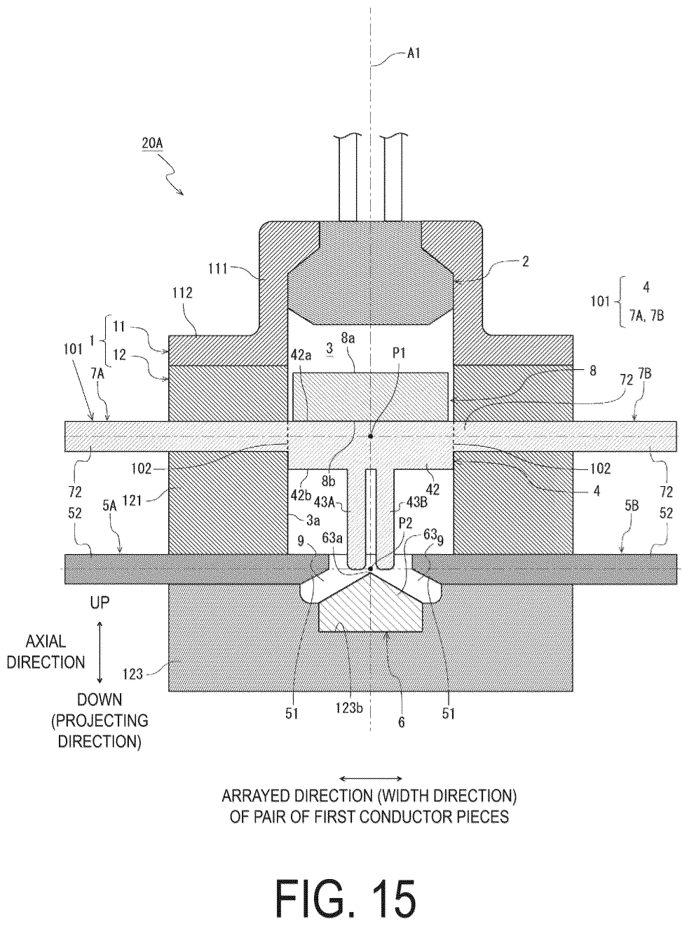

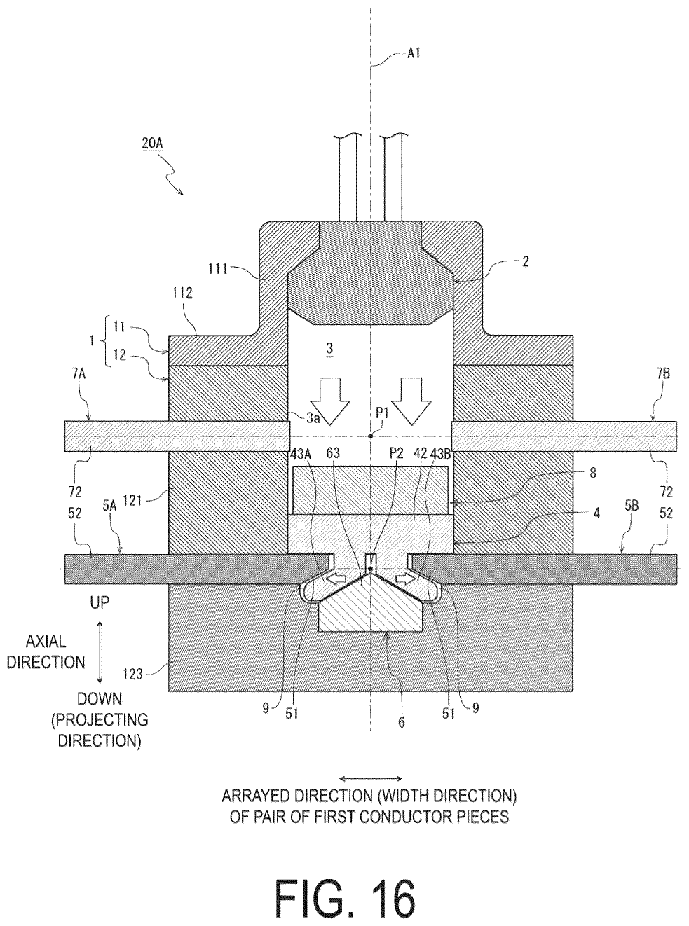

Below, a switching device 20A according to a modified example of the second embodiment will be described. In the description of the switching device 20A, description will be made with a focus on the differences from the switching device 20. Elements that are the same as those of the switching device 20 will be denoted using the same references signs, and detailed description thereof will be omitted. FIG. 15 is a vertical cross-sectional view for describing a state before actuation of the switching device 20A according to the modified example of the second embodiment. FIG. 16 is a vertical cross-sectional view for describing a state after actuation of the switching device 20A according to the modified example of the second embodiment. As illustrated in FIG. 15 and FIG. 16, the switching device 20A according to the modified example of the second embodiment differs from the switching device 20 described above in further including the pair of second conductor pieces 7A, 7B as with the switching device 10A according to the modified example of the first embodiment. Further, in the switching device 20A, unlike the switching device 20 described above, the inner wall 3a of the tubular space 3 is not tapered, and the width of the tubular space 3 is constant in projecting direction.

### Configuration

The switching device 20A according to the modified example of the second embodiment, as with the switching device 10A described above, protects an electric device, which is the installation target, when an abnormality occurs in the device by urgently switching a predetermined second electric circuit from a conductive state to an interrupted state and urgently switching a predetermined first electric circuit from an interrupted state to a conductive state.

As illustrated in FIG. 15, in the switching device 20A in the initial state, the projectile 4 and each of the pair of second conductor pieces 7A, 7B are formed as one member. More specifically, a conductor component 101 in which the projectile 4 and the pair of second conductor pieces 7A, 7B are integrated is held in the housing 1 at the first position P1. A material of the conductor component 101 is not particularly limited as long as the material is a conductor, and the material used for the pair of first conductor pieces 5A, 5B described above (for example, copper or the like) can be suitably adopted. In the conductor component 101, the main body portion 42 of the projectile 4 and the inner end portions 71 of each of the pair of second conductor pieces 7A, 7B are connected to each other with the projectile 4 interposed between the pair of second conductor pieces 7A, 7B. Therefore, in the initial state, the projectile 4 is positioned at the first position P1, and the pair of second conductor pieces 7A, 7B are electrically connected via the projectile 4.

Reference sign 102 denotes a connection portion at which each of the projectile 4 and the second conductor pieces 7A, 7B are connected. In the connection portion 102, for example, a notch may be provided by beveling a member surface, and a thickness of the connection portion 102 may be thin as compared with the other portions, making the connection portion 102 weak as compared with the other portions.

### Operation

Next, operation of the switching device 10A according to the modified example of the first embodiment will be described. In the initial state illustrated in FIG. 15, the pair of first conductor pieces 5A, 5B are spaced apart, and thus the first electric circuit is maintained in an interrupted state. On the other hand, in the initial state, the pair of second conductor pieces 7A, 7B are electrically connected to each other via the projectile 4, and thus the second electric circuit is in a conductive state.

When the igniter 2 is actuated, the piston 8 receiving the energy (pressure) of the combustion gas at the upper end surface 8a is projected in the projecting direction (downward) in the tubular space 3 by using the energy of the combustion gas as a propulsive force. At this time, the lower end surface 8b of the piston 8 presses the upper end surface 42a of the projectile 4, pushing and cutting the connection portion 102 of the conductor component 101 and separating the projectile 4 from the conductor component 101. The projectile 4 separated from the conductor component 101 is projected by using, as a propulsive force, the energy of the combustion gas transmitted via the piston 8, and projected in the projecting direction in the tubular space 3 while pushed by the piston 8. The projectile 4 is moved from the first position P1 by actuation of the igniter 2, resulting in a non-contact state between the projectile 4 and each of the pair of second conductor pieces 7A, 7B, as illustrated in FIG. 16. Accordingly, the electrical connection between the pair of second conductor pieces 7A, 7B via the projectile 4 is disconnected, and the second electric circuit is switched from the conductive state to the interrupted state. Then, as with the switching device 20, the projectile 4 received at the second position P2 by the support 6 and each of the pair of first conductor pieces 5A, 5B come into contact, switching the first electric circuit from the interrupted state to the conductive state. Furthermore, in the switching device 20A, as with the switching device 20, the projectile 4 deformed by the collision with the support 6 is engaged with the pair of first conductor pieces 5A, 5B, and thus the conductive state of the first electric circuit is maintained after actuation.

### Effects

As described above, the switching device 20A according to a modified example of the second embodiment uses a pyro-drive in which pyrotechnics are utilized as an actuation source of the switching device 20A, making it possible to shorten the time required for switching the electric circuit.

Further, in the switching device 20A according to the modified example of the second embodiment, the conductor component 101, in which the main body portion 42 of the projectile 4 is interposed between the pair of second conductor pieces 7A, 7B and these are integrally connected to each other, is incorporated into the housing 1, and the projectile 4 is separated from each of the pair of second conductor pieces 7A, 7B by the energy of the combustion gas released from the igniter 2 upon actuation of the igniter 2. According to this configuration, it is possible to smoothly switch the second electric circuit partially formed by the pair of second conductor pieces 7A, 7B from the conductive state to the interrupted state upon actuation of the igniter 2. Further, the switching device 20A adopts a configuration in which the piston 8 disposed in the tubular space 3 interposedly between the igniter 2 and the projectile 4 is projected in the projecting direction by the energy of the combustion gas, making it possible to more reliably separate the projectile 4 from each of the pair of second conductor pieces 7A, 7B.

Note that, in the switching device 20A, the projectile 4 and each of the pair of second conductor pieces 7A, 7B may be separate members as with the switching device 10A according to the modified example of the first embodiment described above. For example, in the initial state of the switching device 20A, the projectile 4 may be positioned at the first position P1 by being fitted to the inner wall 3a of the tubular space 3, and the projectile 4 and each of the pair of second conductor pieces 7A, 7B may be brought into contact with each other, forming the conductive state of the second electric circuit.

### Other

While embodiments of the electric circuit switching device according to the present disclosure have been described above, each aspect disclosed in the present specification can be combined with any other feature disclosed in the present specification. For example, in the first embodiment, the piston 8 may be provided interposed between the igniter 2 and the projectile 4.

### REFERENCE SIGNS LIST

1 Housing
2 Igniter
3 Tubular space
4 Projectile
5A, 5B Pair of first conductor pieces
6 Support
7A, 7B Pair of second conductor pieces
8 Piston
9 Accommodation space
10, 10A, 20, 20A Electric circuit switching device

1. An electric circuit switching device configured to switch a predetermined first electric circuit from an interrupted state to a conductive state upon actuation, the electric circuit switching device comprising:
a housing;
an igniter provided in the housing and configured to release a combustion gas upon actuation;
a tubular space formed in the housing and extending in one direction;
a projectile having conductivity, positioned at a first position in the tubular space in an initial state before actuation of the igniter, and configured to be projected in a predetermined projecting direction along the tubular space by energy of the combustion gas;
a pair of first conductor pieces provided inserted, in a spaced apart state, into the tubular space at a second position closer to the projecting direction side than the first position, and forming part of the first electric circuit in cooperation with each other; and
a support disposed closer to the projecting direction side than the first position in the tubular space, and configured to receive, at the second position, the projectile projected by actuation of the igniter, wherein
when the igniter is actuated and the projectile is projected, the projectile deforms by collision with the support, the projectile and each of the pair of first conductor pieces come into contact with each other, and the projectile becomes engaged with the pair of first conductor pieces, switching the first electric circuit from the interrupted state to the conductive state.

2. The electric circuit switching device according to claim 1, wherein
the pair of first conductor pieces are provided inserted at the second position in a manner that the pair of first conductor pieces oppose each other with the projectile, received by the support, interposed therebetween,
the support includes a protruding portion protruding toward a side opposite to the projecting direction,
a recessed portion is formed in an end surface of the projectile on the projecting direction side, and
when the igniter is actuated and the projectile is projected, the projectile enters between the pair of first conductor pieces, the protruding portion enters the recessed portion, and the protruding portion deforms the projectile, pressing and expanding the recessed portion, thereby increasing a width of the projectile in an arrayed direction of the pair of first conductor pieces and press-fitting the projectile between the pair of first conductor pieces.

3. The electric circuit switching device according to claim 2, wherein
the protruding portion is formed in a triangular cross-sectional shape, increasing in width in the arrayed direction of the pair of first conductor pieces gradually from a distal end portion of the protruding portion in the projecting direction,
the recessed portion is formed in a triangular cross-sectional shape, increasing in width in the arrayed direction of the pair of first conductor pieces gradually from a bottom portion of the recessed portion in the projecting direction, and
a spread angle of the protruding portion is set larger than a spread angle of the recessed portion.

4. The electric circuit switching device according to claim 1, wherein
the pair of first conductor pieces are provided inserted at the second position in a manner that the pair of first conductor pieces oppose each other with the projectile, received by the support, interposed therebetween,
the support includes a protruding portion protruding toward a side opposite to the projecting direction,
the projectile includes
a main body portion positioned at the first position in the initial state, and
a pair of extending portions provided in line in the arrayed direction of the pair of first conductor pieces and extending from the main body portion in the projecting direction, and
when the igniter is actuated and the projectile is projected, the pair of extending portions enter between the pair of first conductor pieces, the protruding portion enters between the pair of extending portions, and the protruding portion deforms the projectile in a manner that the pair of extending portions are bent outward, thereby sandwiching one of the pair of first conductor pieces between one of the pair of extending portions and the main body portion and sandwiching the other of the pair of first conductor pieces between the other of the pair of extending portions and the main body portion.

5. The electric circuit switching device according to claim 4, wherein
an accommodation space configured to accommodate the pair of extending portions bent by the protruding portion is formed between the protruding portion and each of the pair of first conductor pieces.

6. The electric circuit switching device according to claim 1, the electric circuit switching device configured to further switch a predetermined second electric circuit from a conductive state to an interrupted state upon actuation, the electric circuit switching device further comprising:
a pair of second conductor pieces provided inserted, in a spaced apart state, into the tubular space at the first position, and forming part of the second electric circuit in cooperation with each other, wherein
in the initial state, the pair of second conductor pieces are electrically connected to each other via the projectile, causing the second electric circuit to be in the conductive state, and
an electrical connection between the pair of second conductor pieces via the projectile is disconnected when the igniter is actuated and the projectile is projected, switching the second electric circuit from the conductive state to the interrupted state.

7. The electric circuit switching device according to claim 6, wherein
in the initial state, the projectile is interposed between the pair of second conductor pieces, integrally connecting the projectile and the pair of second conductor pieces, and
the projectile is separated from each of the pair of second conductor pieces by the energy of the combustion gas.

8. The electric circuit switching device according to claim 1, wherein
the projectile is fitted to an inner wall of the tubular space, and
the inner wall of the tubular space is formed with a width of the tubular space gradually decreasing in the projecting direction.

9. The electric circuit switching device according to claim 1, further comprising:
a piston disposed in the tubular space, interposedly between the igniter and the projectile, and configured to be projected in the projecting direction by the energy of the combustion gas.

10. The electric circuit switching device according to claim 2, the electric circuit switching device configured to further switch a predetermined second electric circuit from a conductive state to an interrupted state upon actuation, the electric circuit switching device further comprising:
a pair of second conductor pieces provided inserted, in a spaced apart state, into the tubular space at the first position, and forming part of the second electric circuit in cooperation with each other, wherein
in the initial state, the pair of second conductor pieces are electrically connected to each other via the projectile, causing the second electric circuit to be in the conductive state, and
an electrical connection between the pair of second conductor pieces via the projectile is disconnected when the igniter is actuated and the projectile is projected, switching the second electric circuit from the conductive state to the interrupted state.

11. The electric circuit switching device according to claim 3, the electric circuit switching device configured to further switch a predetermined second electric circuit from a conductive state to an interrupted state upon actuation, the electric circuit switching device further comprising:
a pair of second conductor pieces provided inserted, in a spaced apart state, into the tubular space at the first position, and forming part of the second electric circuit in cooperation with each other, wherein
in the initial state, the pair of second conductor pieces are electrically connected to each other via the projectile, causing the second electric circuit to be in the conductive state, and
an electrical connection between the pair of second conductor pieces via the projectile is disconnected when the igniter is actuated and the projectile is projected, switching the second electric circuit from the conductive state to the interrupted state.

12. The electric circuit switching device according to claim 4, the electric circuit switching device configured to further switch a predetermined second electric circuit from a conductive state to an interrupted state upon actuation, the electric circuit switching device further comprising:
a pair of second conductor pieces provided inserted, in a spaced apart state, into the tubular space at the first position, and forming part of the second electric circuit in cooperation with each other, wherein
in the initial state, the pair of second conductor pieces are electrically connected to each other via the projectile, causing the second electric circuit to be in the conductive state, and
an electrical connection between the pair of second conductor pieces via the projectile is disconnected when the igniter is actuated and the projectile is projected, switching the second electric circuit from the conductive state to the interrupted state.

13. The electric circuit switching device according to claim 5, the electric circuit switching device configured to further switch a predetermined second electric circuit from a conductive state to an interrupted state upon actuation, the electric circuit switching device further comprising:
a pair of second conductor pieces provided inserted, in a spaced apart state, into the tubular space at the first position, and forming part of the second electric circuit in cooperation with each other, wherein
in the initial state, the pair of second conductor pieces are electrically connected to each other via the projectile, causing the second electric circuit to be in the conductive state, and
an electrical connection between the pair of second conductor pieces via the projectile is disconnected when the igniter is actuated and the projectile is projected, switching the second electric circuit from the conductive state to the interrupted state.

14. The electric circuit switching device according to claim 2, wherein
the projectile is fitted to an inner wall of the tubular space, and
the inner wall of the tubular space is formed with a width of the tubular space gradually decreasing in the projecting direction.

15. The electric circuit switching device according to claim 3, wherein
the projectile is fitted to an inner wall of the tubular space, and
the inner wall of the tubular space is formed with a width of the tubular space gradually decreasing in the projecting direction.

16. The electric circuit switching device according to claim 4, wherein
the projectile is fitted to an inner wall of the tubular space, and
the inner wall of the tubular space is formed with a width of the tubular space gradually decreasing in the projecting direction.

17. The electric circuit switching device according to claim 5, wherein
the projectile is fitted to an inner wall of the tubular space, and
the inner wall of the tubular space is formed with a width of the tubular space gradually decreasing in the projecting direction.

18. The electric circuit switching device according to claim 2, further comprising:
a piston disposed in the tubular space, interposedly between the igniter and the projectile, and configured to be projected in the projecting direction by the energy of the combustion gas.

19. The electric circuit switching device according to claim 3, further comprising:
a piston disposed in the tubular space, interposedly between the igniter and the projectile, and configured to be projected in the projecting direction by the energy of the combustion gas.

20. The electric circuit switching device according to claim 4, further comprising:
a piston disposed in the tubular space, interposedly between the igniter and the projectile, and configured to be projected in the projecting direction by the energy of the combustion gas.
